(19) United States
(12) Patent Application Publication
(10) Pub. No.: US 2014/0026070 A1
(43) Pub. Date: Jan. 23, 2014

(54) DYNAMIC FOCUS FOR CONVERSATION VISUALIZATION ENVIRONMENTS

(71) Applicants: Ankit Tandon, Bellevue, WA (US); Annika Elias, Redmond, WA (US); Blaine Carpenter, Lake Forest Park, WA (US); Prarthana Panchal, Seattle, WA (US); Michael Hill, Shoreline, WA (US)

(72) Inventors: Ankit Tandon, Bellevue, WA (US); Annika Elias, Redmond, WA (US); Blaine Carpenter, Lake Forest Park, WA (US); Prarthana Panchal, Seattle, WA (US); Michael Hill, Shoreline, WA (US)

(73) Assignee: MICROSOFT CORPORATION, Redmond, WA (US)

(21) Appl. No.: 13/551,238

(22) Filed: Jul. 17, 2012

(51) Int. Cl. G06F 3/01

(52) U.S. Cl. 715/753

(57) ABSTRACT

A conversation visualization environment may be rendered that includes conversation communications and conversation modalities. The relevance of each of the conversation modalities may be identified and a focus of the conversation visualization environment modified based on their relevance. In another implementation, conversation communications are received for presentation by conversation modalities. An in-focus modality may be selected from the conversation modalities based at least on a relevance of each of the conversation modalities.

### TECHNICAL FIELD

Aspects of the disclosure are related to computer hardware and software technologies and in particular to conversation visualization environments.

### TECHNICAL BACKGROUND

Conversation visualization environments allow conversation participants to exchange communications in accordance with a variety of conversation modalities. For instance, participants may engage in video exchanges, voice calls, instant messaging, white board presentations, and desktop views, or other modes. Microsoft® Lync® is an example application program suitable for providing such conversation visualization environments.

As the feasibility of exchanging conversation communications by way of a variety of conversation modalities has increased, so too have the technologies with which conversation visualization environments can be delivered. For example, conversation participants may engage in a video call, voice call, or instant messaging session using traditional desktop or laptop computers, as well as tablets, mobile phones, gaming systems, dedicated conversation systems, or any other suitable communication device. Different architectures can be employed to deliver conversation visualization environments including centrally managed and peer-to-peer architectures.

Many conversation visualization environments provide features that are dynamically enabled or otherwise triggered in response to various events. For example, emphasis may be placed on one particular participant or another in a gallery of video participants based on which participant is speaking at any given time. Other features give participants notice of incoming communications, such as a pop-up bubble alerting a participant to a new chat message, voice call, or video call. Yet other features allow participants to organize or layout various conversation modalities in their preferred manner.

In one scenario, a participant may organize his or her environment such that a video gallery is displayed more prominently or with visual emphasis relative to the instant messaging screen, white board screen, or other conversation modalities. In contrast, another participant may organize his or her environment differently such that the white board screen takes prominence over the video gallery. In either case, alerts may be surfaced with respect to any of the conversation modalities informing the participants of new communications.

### Overview

Provided herein are systems, methods, and software for facilitating a dynamic focus for a conversation visualization environment. In at least one implementation, a conversation visualization environment may be rendered that includes conversation communications and conversation modalities. The relevance of each of the conversation modalities may be identified and a focus of the conversation visualization environment modified based on their relevance. In another implementation, conversation communications are received for presentation by conversation modalities. An in-focus modality may be selected from the conversation modalities based at least on a relevance of each of the conversation modalities. A conversation visualization environment may be rendered with the conversation communications presented within the conversation modalities. In at least some implementations, a visual emphasis may be placed on the in-focus modality.

This Overview is provided to introduce a selection of concepts in a simplified form that are further described below in the Technical Disclosure. It should be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates a conversation scenario in an implementation.

FIG. 2 illustrates a visualization process in an implementation.

FIG. 3 illustrates a visualization process in an implementation.

FIG. 4 illustrates a computing system in an implementation.

FIG. 5 illustrates a communication environment in an implementation.

FIG. 6 illustrates a visualization process in an implementation.

FIG. 7 illustrates a conversation scenario in an implementation.

### TECHNICAL DISCLOSURE

Implementations described herein provide for improved conversation visualization environments. In a brief discussion of an implementation, a computing system having suitable capabilities may execute a communication application that facilitates the presentation of conversations. The system and software may render, generate, or otherwise initiate a process to display a conversation visualization environment to a conversation participant. The conversation visualization environment may include several conversation communications, such as video, voice, instant messages, screen shots, document sharing, and whiteboard displays. A variety of conversation modalities, such as a video conference modality, an instant messaging modality, and a voice call modality, among other possible modalities, may be provided by the conversation visualization environment.

In operation, the system and software may automatically identify a relevance of each of the conversation modalities to the conversation visualization environment. Based on their relevance, the system and software may modify or initiate a modification to a focus of the conversation visualization environment. For example, a visual emphasis may be placed on a conversation modality based on its relevance.

In some implementations, the system and software identify the relevance of each of the conversation modalities responsive to receiving new conversation communications. In yet other implementations, a determination is made whether or not to initiate the modification to the focus of the conversation visualization environment based at least in part on a present state of the conversation visualization environment and the relevance of each of the conversation modalities.

Conversation communications may be surfaced in a variety of ways. For example, with respect to an in-focus modality, communications may be surfaced within a main view of the modality. With respect to modalities that are not the in-focus modality, communications may be surfaced via a supplemental view of the modality. In fact, a reply may be received through the supplemental view.

In some implementations, focus criteria on which relevance may be based may include identity criteria compared against a participant identity, behavior criteria compared against participant behavior, and content criteria compared against contents of the conversation communications. A participant identity may be, for example, a login identity, email address, service handle, phone number, or other similar identity that can be used to identify a participant. Participant behavior may include, for example, a level of interaction with an environment by a participant, a level of interaction with a modality by a participant, how recently a participant engaged with a modality, and the like. The content of various conversation communications may be, for example, words or phrases represented in text-based conversation communications, spoken words carried in audio or video communications, and words or phrases represented within documents, as well as other types of content.

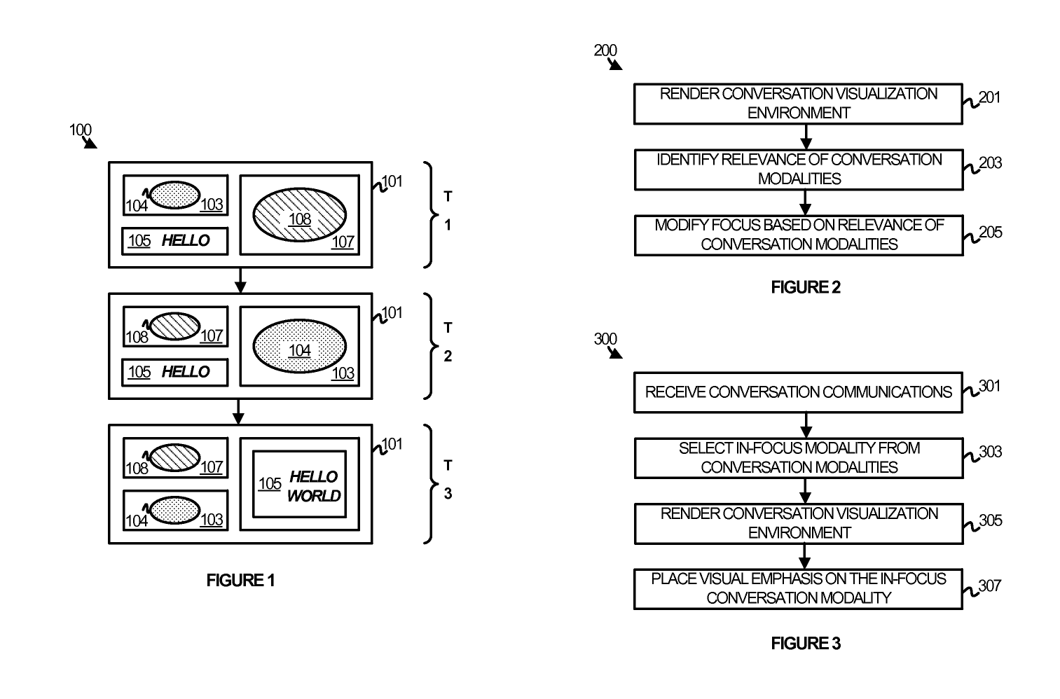

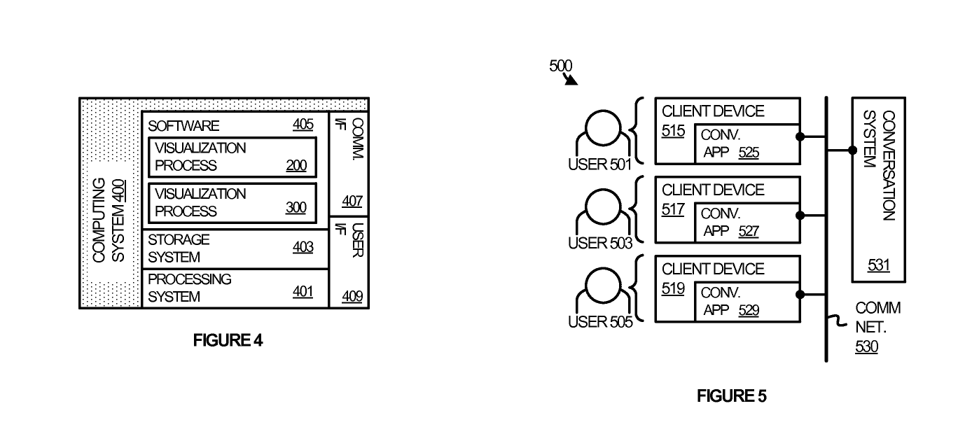

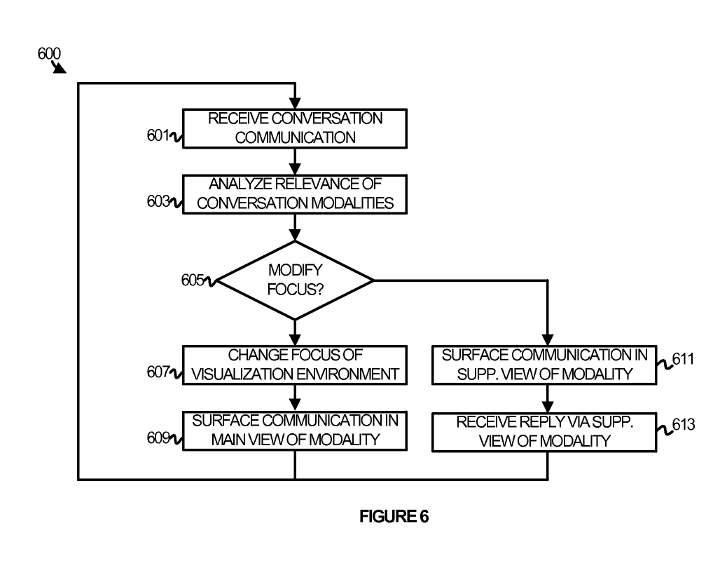

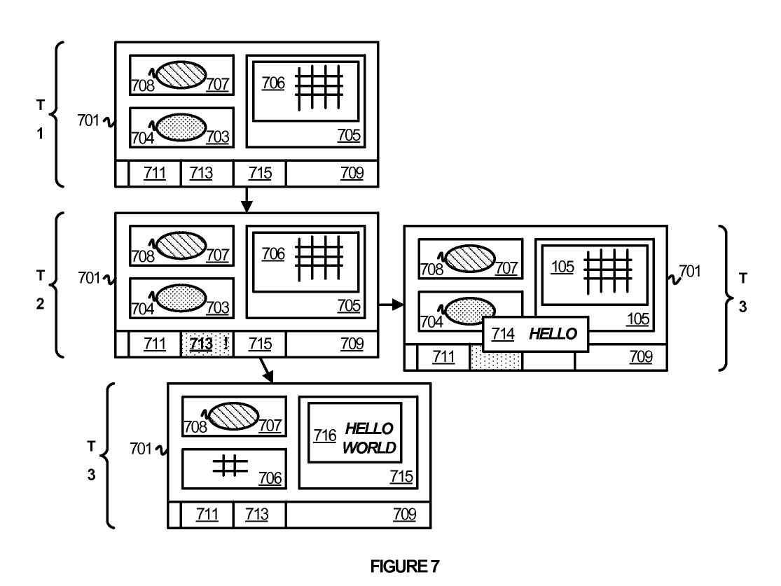

FIGS. 1-7, discussed in more detail below, generally depict various scenarios, systems, processes, architectures, and operational sequences for carrying out various implementations. With respect to FIGS. 1-3, a conversation scenario is illustrated in FIG. 1, as well as two processes in FIG. 2 and FIG. 3 for dynamically focusing a conversation visualization environment. FIG. 4 illustrates a computing system suitable for implementing visualization processes and a conversation visualization environment. FIG. 5 illustrates a communication environment. FIG. 6 illustrates another visualization environment, while FIG. 7 illustrates another conversation scenario.

Turning now to FIG. 1, visualization scenario 100 illustrates a conversation visualization environment 101 having a dynamically changing focus. In this implementation, conversation visualization environment 101 has one conversation modality as its initial focus. Subsequently, the focus of conversation visualization environment 101 changes to a different conversation modality. The focus changes yet again to another conversation modality.

In particular, at time T1 conversation visualization environment 101 includes video modality 103, instant messaging modality 105, and video modality 107. Note that these modalities are merely illustrative and intended to represent of some possible non-limiting modalities. Video modality 103 may be any modality capable of presenting conversation video. Video modality 103 includes object 104, possibly corresponding to a conversation participant, some other object, or some other video content that may be presented by video modality 103. Video modality 107 may also be any modality capable of presenting conversation video. Video modality 107 includes object 108, possibly corresponding to another conversation participant, another object, or some other video content. Instant messaging modality 105 may be any modality capable of presenting messaging information. Instant messaging modality 105 includes the text “hello world, possibly representative of text or other instant messaging content that may be presented by instant messaging modality 105.

Initially, conversation visualization environment 101 is rendered with a focus on video modality 107, as may be evident from the larger size of video modality 107 relative to video modality 103 and instant messaging modality 105. However, the focus of conversation visualization environment 101 may change, as illustrated in FIG. 1 at time T2. From time T1 to time T2, the focus of conversation visualization environment 101 has changed to video modality 103. This change may be evident from the larger size of video modality 103 relative to video modality 107 and instant messaging modality 105. Finally, at time T3 the focus of conversation visualization environment 101 has changed to instant messaging modality 105, as evident by its larger size relative to video modality 103 and video modality 107. Relative size or the relative share of an environment occupied by a given modality may be one technique to manifest the focus of a visualization environment, although other techniques are possible. The change in focus may occur for a number of reasons or otherwise be triggered by a variety of events, as will be discussed in more detail below with respect to FIG. 2 and FIG. 3.

Referring now to FIG. 2, visualization process 200 is illustrated and may be representative of any process or partial process carried out when changing the focus of conversation visualization environment 101. The following discussion of FIG. 2 will be made with reference to FIG. 1 for purpose of clarity, although it should be understood that such processes may apply to a variety of visualization environments.

To begin, conversation visualization environment 101 is rendered, including video modality 103, instant messaging modality 105, and video modality 107 (step 201). Conversation visualization environment 101 may be rendered to support a variety of contexts. For example, a participant interfacing with conversation visualization environment 101 may wish to engage in a video conference, video call, voice call, instant message session, or some other conversation session with another participant or participants. Indeed, conversation visualization environment 101 may support multiple conversations simultaneously and need not be limited to a single conversation. Thus, the various modalities and conversation communications illustrated in FIG. 1 may be associated with one or more conversations.

Rendering conversation visualization environment 101 may include part or all of any steps, processes, sub-processes, or other functions typically involved in generating the images and other associated information that may form an environment. For example, initiating a rendering of an environment may be considered rendering the environment. In another example, producing environment images may be considered rendering the environment. In yet another example, communicating images or other associated information to specialized rendering sub-systems or processes may also be considered rendering an environment. Likewise, displaying an environment or causing the environment to be displayed may be considered rendering.

Referring still to FIG. 2, the relevance of video modality 103, instant messaging modality 105, and video modality 107 may be identified (step 205). The relevance may be based on a variety of focus criteria, such as the identity of participants engaged in a conversation or conversations presented by conversation visualization environment 101, the behavior of the participant interfacing with conversation visualization environment 101, the content of the various conversation communications presented within conversation visualization environment 101, as well as other factors. Once determined, the focus of conversation visualization environment 101 may be modified based on the relevance of each conversation modality (step 205). For example, from time T1 to T2 in FIG. 2, the focus of conversation visualization environment 101 changed from video modality 107 to video modality 103, and from time T2 to T3, the focus changed from video modality 103 to instant messaging modality 105.

Referring now to FIG. 3, visualization process 300 is illustrated and may be representative of any process or partial process carried out when changing the focus of conversation visualization environment 101. The following discussion of FIG. 3 will be made with reference to FIG. 1 for purpose of clarity, although it should be understood that such processes may apply to a variety of visualization environments.

To begin, conversation communications are received for presentation within conversation visualization environment 101 (step 301). For example, video communications may be received for presentation by video modality 103 and video modality 107, while instant messaging communications may be received for presentation by instant messaging modality 105. Note that various communications of various types may be received simultaneously, in serial, in a random order, or any other order in which communications may be received during the course of a conversation or multiple conversations. Note also that the received communications may be associated with one conversation but may also be associated with multiple conversations. The conversations may be one-on-one conversations, but may be multi-party conversations, such as a conference call or any other multi-party session.

Next, an in-focus modality may be selected from video modality 103, instant messaging modality 105, and video modality 107 (step 303). The selection may be based on a variety of criteria, such as the identity of participants, the content of communications exchanged during the conversations, or the behavior of a participant or participants with respect to conversation visualization environment 101.

Conversation visualization environment 101 may ultimately be rendered (step 305) such that video modality 103, instant messaging modality 105, and video modality 107 are displayed to a participant. A visual emphasis is placed on the in-focus modality, allowing the in-focus modality to stand-out or otherwise appear with emphasis relative to the other modalities. As mentioned above, from time T1 to T2 in FIG. 2, the focus of conversation visualization environment 101 changed from video modality 107 to video modality 103, and from time T2 to T3, the focus changed from video modality 103 to instant messaging modality 105.

Referring now to FIG. 4, a computing system suitable for implementing a visualization process is illustrated. Computing system 400 is generally representative of any computing system or systems on which visualization process 200 may be suitably implemented. Optionally, or in addition, computing system 400 may also be suitable for implementing visualization process 300. Furthermore, computing system 400 may also be suitable for implementing conversation visualization environment 101. Examples of computing system 400 include server computers, client computers, virtual machines, distributed computing systems, personal computers, mobile computers, media devices, Internet appliances, desktop computers, laptop computers, tablet computers, notebook computers, mobile phones, smart phones, gaming devices, and personal digital assistants, as well as any combination or variation thereof.

Computing system 400 includes processing system 401, storage system 403, software 405, and communication interface 407. Computing system 400 also includes user interface 409, although this is optional. Processing system 401 is operatively coupled with storage system 403, communication interface 407, and user interface 409. Processing system 401 loads and executes software 405 from storage system 403. When executed by computing system 400 in general, and processing system 401 in particular, software 405 directs computing system 400 to operate as described herein for visualization process 200 and/or visualization process 300. Computing system 400 may optionally include additional devices, features, or functionality not discussed here for purposes of brevity and clarity.

Referring still to FIG. 4, processing system 401 may comprise a microprocessor and other circuitry that retrieves and executes software 405 from storage system 403. Processing system 401 may be implemented within a single processing device but may also be distributed across multiple processing devices or sub-systems that cooperate in executing program instructions. Examples of processing system 401 include general purpose central processing units, application specific processors, and logic devices, as well as any other type of processing device, combinations of processing devices, or variations thereof.

Storage system 403 may comprise any storage media readable by processing system 401 and capable of storing software 405. Storage system 403 may include volatile and nonvolatile, removable and non-removable media implemented in any method or technology for storage of information, such as computer readable instructions, data structures, program modules, or other data. Storage system 403 may be implemented as a single storage device but may also be implemented across multiple storage devices or sub-systems. Storage system 403 may comprise additional elements, such as a controller, capable of communicating with processing system 401.

Examples of storage media include random access memory, read only memory, magnetic disks, optical disks, flash memory, virtual memory, and non-virtual memory, magnetic cassettes, magnetic tape, magnetic disk storage or other magnetic storage devices, or any other medium which can be used to store the desired information and that may be accessed by an instruction execution system, as well as any combination or variation thereof, or any other type of storage media. In some implementations, the storage media may be a non-transitory storage media. In some implementations, at least a portion of the storage media may be transitory. It should be understood that in no case is the storage media a propagated signal.

Software 405 may be implemented in program instructions and among other functions may, when executed by computing system 400, direct computing system 400 to at least: render, generate, or otherwise initiate rendering or generation of a conversation visualization environment that includes conversation communications and conversation modalities; identity the relevance of each of the conversation modalities; and modify a focus of the conversation visualization environment modified based on their relevance.

Software 405 may include additional processes, programs, or components, such as operating system software or other application software. Software 405 may also comprise firmware or some other form of machine-readable processing instructions capable of being executed by processing system 401.

In general, software 405 may, when loaded into processing system 401 and executed, transform processing system 401, and computing system 400 overall, from a general-purpose computing system into a special-purpose computing system customized to facilitate presentation of conversations as described herein for each implementation. Indeed, encoding software 405 on storage system 403 may transform the physical structure of storage system 403. The specific transformation of the physical structure may depend on various factors in different implementations of this description. Examples of such factors may include, but are not limited to the technology used to implement the storage media of storage system 403 and whether the computer-storage media are characterized as primary or secondary storage.

For example, if the computer-storage media are implemented as semiconductor-based memory, software 405 may transform the physical state of the semiconductor memory when the program is encoded therein. For example, software 405 may transform the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate this discussion.

It should be understood that computing system 400 is generally intended to represent a computing system with which software 405 is deployed and executed in order to implement visualization process 200 and/or visualization process 300 and optionally render conversation visualization environment 101. However, computing system 400 may also represent any computing system suitable for staging software 405 from where software 405 may be distributed, transported, downloaded, or otherwise provided to yet another computing system for deployment and execution, or yet additional distribution.

Referring again to FIG. 1, through the operation of computing system 400 employing software 405, transformations may be performed with respect to conversation visualization environment 101. As an example, conversation visualization environment 101 could be considered transformed from one state to another when subject to visualization process 200 and/or visualization process 300. In a first state, conversation visualization environment 101 may have an initial focus. Upon analyzing the relevance of each modality included therein, the focus of conversation visualization environment 101 may be modified, thereby changing conversation visualization environment 101 to a second, different state.

Referring again to FIG. 4, communication interface 407 may include communication connections and devices that allow for communication between computing system 400 other computing systems not shown over a communication network or collection of networks. Examples of connections and devices that together allow for inter-system communication include network interface cards, antennas, power amplifiers, RF circuitry, transceivers, and other communication circuitry. The aforementioned network, connections, and devices are well known and need not be discussed at length here.

User interface 409 may include a mouse, a voice input device, a touch input device for receiving a gesture from a user, a motion input device for detecting non-touch gestures and other motions by a user, and other comparable input devices and associated processing elements capable of receiving user input from a user, such as a camera or other video capture device. Output devices such as a display, speakers, printer, haptic devices, and other types of output devices may also be included in user interface 409. The aforementioned user input and user output devices are well known in the art and need not be discussed at length here. User interface 409 may also include associated user interface software executable by processing system 401 in support of the various user input and output devices discussed above. Separately or in conjunction with each other and other hardware and software elements, the user interface software and devices may be considered to provide a graphical user interface, a natural user interface, or any other kind of user interface suitable to the interfacing purposes discussed herein.

FIG. 5 illustrates communication environment 500 in which visualization scenario 100 may occur. In addition, communication environment 500 includes various client devices 515, 517, and 519 that may be employed to carry out conversations between conversation users 501, 503, and 505 over communication network 530. Client devices 515, 517, and 519 include conversation applications 525, 527, and 529 respectively, capable of being executed thereon to generate conversation visualization environments, such as conversation visualization environment 101. Computing system 400 is representative of any system or device suitable for implementing client devices 515, 517, and 519.

Conversation environment 500 optionally includes conversation system 531 depending upon how a conversation service may be provided. For example, a centrally managed conversation service may route conversation communications exchanged between client devices 515, 517, and 519 through conversation system 531. Conversation system 531 may provide various functions, such as servicing client requests and processing video, as well as performing other functions. In some implementations, the functions provided by conversation system 531 may be distributed amongst client devices 515, 517, and 519.

In operation, users 501, 503, and 505 may interface with conversation applications 525, 527, and 529 respectively in order to engage in conversations with each other or other participants. Each application may be capable of rendering conversation visualization environments similar to conversation visualization environment 101, as well as implanting visualization processes, such as visualization processes 200 and 300.

In an example scenario, client device 515 executing conversation application 525, may generate a conversation visualization environment with one conversation modality as its initial focus. Subsequently, the focus of the conversation visualization environment may change to a different conversation modality. The focus may change yet again to another conversation modality.

For example, the conversation visualization environment may include a video modality or modalities capable of presenting conversation video of the other participants in the conversation, users 503 and 505. The visualization environment may also include an instant messaging modality capable of presenting messaging information exchanged between users 501, 503, and 505. Initially, the conversation visualization environment may be rendered with a focus on a video modality, but then the focus may change to the instant messaging modality. The change in focus may be indicated by a change in relative size or the change in relative share of an environment occupied by a given modality relative to other modalities. Optionally, the focus may be indicated by the location within an environment where an in-focus modality is placed. For example, the size of a modality may remain the same, but it may occupy a new, more central or prominent position within a viewing environment.

The change in focus may be based on the relevance of the various modalities relative to each other. The relevance may be based on a variety of focus criteria, such as the identity of participants engaged in a conversation or conversations presented by the conversation visualization environment, the behavior of the participant interfacing with the conversation visualization environment, or the content of the various conversation communications presented within conversation visualization environment, as well as other factors. Once determined, the focus of the conversation visualization environment may be modified.

FIG. 6 illustrates another visualization process 600 in an implementation. Visualization process 600 may be executed within the context of a conversation application running on client devices 515, 517, and 519 capable of producing a conversation visualization environment. To begin, conversation communications are received (step 601). The relevance of each modality is analyzed (step 603) and a determination made whether or not to modify the focus of the conversation visualization environment (step 605).

In some cases, the focus of the conversation visualization environment may be changed (step 607). For example, the focus of the environment may be changed from one modality to another modality determined, based on relevance, to be selected as an in-focus modality. In the event that new communications are received, the communications may be surfaced through a main view of the in-focus modality (step 609). However, in some cases it may be determined that the focus of the conversation visualization environment need not change. In the event that new communications are received under such circumstances, the communications may be surfaced through a supplemental view of the associated modality (step 611). In fact, replies to the surfaced communication may be received via the supplemental view (step 613).

FIG. 7 illustrates one visualization scenario 700 representative of an implementation of visualization process 600. At time T1, conversation visualization environment 701 is rendered. Conversation visualization environment 701 includes video modality 703, white board modality 705, and video modality 707. Conversation visualization environment 701 also includes a modality preview bar 709, which includes several modality previews. The modality previews include a preview of an instant messaging modality 715, as well as other of modalities 711 and 713. The focus of conversation visualization environment 701 is initially white board modality 705.

At time T2, a notification is received with respect to the preview of modality 713 associated with incoming communications. The alert is presented, in this example, by changing the visual appearance of the preview of modality 713, although other ways of providing the notification are possible. Upon receiving the notification or otherwise becoming aware of the incoming communications, a determination is made whether or not to change the focus of conversation visualization environment 701.

In a first possible example, it is determined that the focus change from white board modality 705 to instant messaging modality 715. Thus, instant messaging modality 715 is presented within conversation visualization environment 701 as relatively larger or otherwise occupying a greater share of display space than the other modalities. In a second possible example, it is determined that the focus need not change away from white board modality 705. Rather, a supplemental view 714 of instant messaging modality 715 is presented that contains the content of the incoming communications. Note that a similar operation may occur when it is determined that the focus change, but not to instant messaging modality 715. For example, had the focus changed to modality 711, then modality 711 might have been displayed in a relatively larger fashion, but the incoming communications still presented via the supplemental view 714 of instant messaging modality 715.

The following discussion of various factors that may be considered when determining the relevance of conversation modalities is provided for illustrative purposes and is not intended to limit the scope of the present disclosure. When determining or otherwise identifying the relevance of any given modality and any given time, a wide variety of criteria may be considered. In an implementation, at any point during a conversation, meeting, conference, or other similar collaboration, a level of activity of each modality and a level of user participation or interaction with each modality up to that point in the collaboration may be considered.

For example, the activity level of an instant messaging modality may correspond to whether or not any participants are presently typing within the modality, how many participants may be presently typing within the modality, how recently instant messaging communications were exchanged via the modality, and whether or not the subject participant is presently typing. The activity level of a video modality may correspond to how many participants have their respective cameras or other capture devices turned on or enabled, how much movement is occurring in front of each camera, how many people are speaking or otherwise interacting in a meaningful way through video, and how much activity, such as cursor movements and other interaction, is present with respect to the video modality.

The identity of each participant may also contribute to the relevance of each modality. For example, if a meeting organizer or chair is typing within an instant messaging modality, even if no other participants are typing within the instant messaging modality, then that modality may be considered very relevant. A similar relevance determination may be made with respect to other types of modalities based on the identity of the various participants engaged with those modalities.

How recently or frequently a participant has joined a particular modality may also impact the relevance of that modality. For instance, when a new participant joins a conversation via a video modality, the relevance of the video modality may increase relative to other modalities, at least for the time being while the new participant is introduced to other participants.

It may possible for participants to pin or otherwise designate a modality or modalities for increased relevance. For example, a participant may pin a particular video modality within which video of another participant is displayed, thereby ensuring that the particular video modality generally be displayed with emphasis relative to at least some other modalities. However, it should be understood that yet another or other modalities may be displayed with more relevance than the pinned modality.

Indeed, it may be understood that a range of relevancy is possible, although a binary relevancy measure is also possible. For example, in some implementations only a single modality may qualify as the most relevant modality, thereby allowing for only that single modality to be rendered with visual emphasis relative to the other modalities. The other modalities may then be displayed with similar visual emphasis as each other. However, there may be a range of visual emphasis placed on each modality, whereby some modalities are displayed with similar emphasis, while other modalities are displayed with different emphasis. In either case, at least one modality may be displayed with at least greater visual emphasis than at least one other modality. In many implementations, the most relevant modality will be displayed with the most visual emphasis, although as noted above multiple modalities may be identified as most relevant and displayed simultaneously with visual emphasis. Even if two or more modalities are determined to have similar relevancy, differences may exist in their respective visual emphasis. A wide variety of range of relevancy and corresponding visual emphasis is possible and should not be limited to just the examples disclosed herein.

Content within conversation communications may also be considered when determining the relevancy of modalities. For example, how recently content has been shared, such as slides, a desktop view, or an application document, may impact the relevancy of the corresponding modality by which it was shared. In another example, activity within the sharing of content, such as mouse clicks or movement on a document being shared via a white board or desktop share modality, may also drive the relevancy determination. In yet another example, the browsing order through which a document or other content is browsed may be indicative of its relevancy. Browsing asynchronously through a slide presentation may indicate high relevance, while browsing synchronously may indicate otherwise.

User interaction with content may be another indication of the relevance of the underlying modality. For example, if participants are annotating documents exchanged via a white board or desktop share modality, the modality may be considered to be of relative higher relevance. In one scenario, interactive content provided by way of a modality may correspond to high relevance for that modality. For example, user-initiated polls or poll results provided by way of a document modality, email modality, or chat modality may drive a relatively high relevancy determination for the underlying modality. Still other examples include considering whether or not a peripheral presentation device, such as a point tool, is being used within the context of a conversation, or whether or not a presenter is advancing through a document, such as a slide show. It may be appreciated that a wide variety of user interactions with content may be considered in the course of analyzing modality relevance.

In some implementations, participants may be able to create and save personalized views for display when engaged in later conversations. For example, a user may pin or otherwise specify that a particular modality always be given greater weight when determining relevancies. In this manner, a preferred modality, such as an instant message modality, may always be surfaced in its main view and given prominent display within a conversation visualization environment or view. In another variation, it may be possible for a participant to pause the automatic analysis and focus modifications discussed above. In yet another variation, it may be possible to dampen or regulate the frequency with which modifications to a focus are made.

In other implementations, a distinction may be made within a conversation visualization environment between content-related modalities and people-related modalities. Content-related modalities may be, for example, those modalities capable of presenting content, such as desktop view modalities or white board modalities. People-related modalities may be, for example, those modalities capable of presenting user-generated content, such as video, voice call, and instant messaging modalities.

In such an implementation, a dual-focus of a conversation visualization environment may be possible. In a dual-focus implementation, there may be one focus generally related to content-related modalities, while another focus is generally related to people-related modalities. The relevancy of the various content-related modalities may be analyzed separate from the relevancy of the various people-related modalities. The conversation visualization environment can then be rendered with a focus on a content-related modality and a focus on a people-related modality. For example, a desktop view modality may be rendered with greater visual emphasis than a white board modality, while a video modality may be rendered simultaneously and with a greater visual emphasis than an instant messaging modality. Indeed, the conversation visualization environment may be graphically split in half such that the content-related modalities are presented within area of the environment, while the people-related modalities are presented in a different area.

The functional block diagrams, operational sequences, and flow diagrams provided in the Figures are representative of exemplary architectures, environments, and methodologies for performing novel aspects of the disclosure. While, for purposes of simplicity of explanation, the methodologies included herein may be in the form of a functional diagram, operational sequence, or flow diagram, and may be described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

The included descriptions and figures depict specific implementations to teach those skilled in the art how to make and use the best mode. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. One or more computer readable media having stored thereon program instructions for facilitating presentation of conversations that, when executed by a computing system, direct the computing system to at least:
render a conversation visualization environment comprising a plurality of conversation communications and a plurality of conversation modalities;
identify a relevance of each of the plurality of conversation modalities; and
modify a focus of the conversation visualization environment based on the relevance of each of the plurality of conversation modalities.

2. The one or more computer readable media of claim 1 wherein the program instructions direct the computing system to identify the relevance of each of the plurality of conversation modalities responsive to receiving new conversation communications of the plurality of conversation communications.

3. The one or more computer readable media of claim 1 wherein the program instructions further direct the computing system to determine whether or not to initiate a modification to the focus of the conversation visualization environment based at least in part on a present state of the conversation visualization environment and the relevance of each of the plurality of conversation modalities.

4. The one or more computer readable media of claim 3 wherein the program instructions direct the computing system to modify the focus of the conversation visualization environment responsive to determining to initiate the modification.

5. The one or more computer readable media of claim 4 wherein the program instructions direct the computing system to, responsive to determining to initiate the modification, surface at least a one conversation communication of the plurality of conversation communications within a main view of a first conversation modality of the plurality of conversation modalities.

6. The one or more computer readable media of claim 5 wherein the program instructions direct the computing system to, responsive to determining to not initiate the modification, surface at least the one conversation communication of the plurality of conversation communications within a supplemental view of the first conversation modality of the plurality of conversation modalities.

7. The one or more computer readable media of claim 6 wherein the program instructions further direct the computing system to receive a reply to the one conversation communication via the supplemental view of the first conversation modality.

8. The one or more computer readable media of claim 1 wherein the focus of the conversation visualization environment comprises a visual emphasis on a first conversation modality relative to other conversation modalities of the plurality of conversation modalities.

9. The one or more computer readable media of claim 8 wherein the plurality of conversation modalities comprise a video conference modality, an instant messaging modality, and a voice call modality.

10. One or more computer readable media having stored thereon program instructions for facilitating presentation of conversations that, when executed by a computing system, direct the computing system to at least:
receive a plurality of conversation communications for presentation by a plurality of conversation modalities;
select an in-focus modality from the plurality of conversation modalities based at least on a relevance of each of the plurality of conversation modalities;
render a conversation visualization environment comprising the plurality of conversation communications presented within the plurality of conversation modalities with a visual emphasis placed on the in-focus modality.

11. The one or more computer readable media of claim 10 wherein the program instructions further direct the computing system to determine the relevance of each of the plurality of conversation modalities based at least in part on focus criteria.

12. The one or more computer readable media of claim 11 wherein the focus criteria comprises identity criteria compared against a participant identity associated with each of the plurality of conversation communications and behavior criteria compared against participant behavior associated with each of the plurality of conversation modalities.

13. The one or more computer readable media of claim 12 wherein the focus criteria further comprises content criteria compared against contents of the plurality of conversation communications.

14. The one or more computer readable media of claim 10 wherein the visual emphasis placed on the in-focus modality comprises a larger share of the conversation visualization environment dedicated to the in-focus modality relative to other shares of the conversation visualization environment dedicated to other conversation modalities of the plurality of conversation modalities.

15. The one or more computer readable media of claim 10 wherein the plurality of conversation modalities comprise a video conference modality, an instant messaging modality, and a voice call modality.

16. A method for presenting conversations, the method comprising:
rendering a conversation visualization environment comprising a plurality of conversation communications and a plurality of conversation modalities;
identifying a relevance of each of the plurality of conversation modalities; and
modifying a focus of the conversation visualization environment based on the relevance of each of the plurality of conversation modalities.

17. The method of claim 16 further comprising determining whether or not to modify the focus of the conversation visualization environment based at least in part on a present state of the conversation visualization environment and the relevance of each of the plurality of conversation modalities.

18. The method of claim 17 wherein the method further comprises:
responsive to determining to modify the focus, surfacing at least a one conversation communication of the plurality of conversation communications within a main view of a first conversation modality of the plurality of conversation modalities; and
responsive to determining to not modify the focus, surface at least the one conversation communication of the plurality of conversation communications within a supplemental view of the first conversation modality of the plurality of conversation modalities.

19. The method of claim 18 wherein the method further comprises receiving a reply to the one conversation communication via the supplemental view of the first conversation modality.

20. The method of claim 16 wherein the focus of the conversation visualization environment comprises a visual emphasis on a first conversation modality relative to other conversation modalities of the plurality of conversation modalities and wherein the plurality of conversation modalities comprises a video conference modality, an instant messaging modality, and a voice call modality.
